(19) United States
(12) Patent Application Publication
(10) Pub. No.: US 2009/0259323 A1
(43) Pub. Date: Oct. 15, 2009

(54) ADSORPTION CONTROL METHOD

(76) Inventors: Partha Kesavan, Williamsville, NY (US); William Randy Esposito, Warrenville, IL (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/099,915

(22) Filed: Apr. 9, 2008

(51) Int. Cl. G05B 13/04; G06N 7/02

(52) U.S. Cl. 700/44; 700/50

(57) ABSTRACT

A method of controlling a pressure swing adsorption unit in which a manipulated variable such as a capacity factor used by such unit in setting the bed cycle time is updated with a manipulated variable computed within a controller. The controller has a feed forward level of control in which the updated manipulated variable is calculated from a probability function when the product is likely to go off spec as determined by the probability function. In such manner, an optimal manipulated variable can be calculated that will maximize recovery in a manner that the probability of the product going off spec will be acceptable. If a specific impurity within the product is above a targeted range, a change to the optimal manipulated variable is computed with the use of a feedback level of control utilizing fuzzy logic.

### FIELD OF THE INVENTION

The present invention relates to an adsorption control method in which a manipulated variable is used in a control unit associated with an adsorption unit to control a cycle time in which beds operating out of phase within adsorption unit are adsorbing impurities within a feed to produce a product stream. More particularly, the present invention relates to such a method in which the value of the manipulated variable is optimized to maximize product recovery in the product stream while preventing the product stream from exceeding an impurity specification by a feed forward level of control incorporating a probability function and the optimized value is further adjusted as necessary by a feed back level of control to decrease the level of the predetermined impurity.

### BACKGROUND OF THE INVENTION

There are a variety of different adsorption units that utilize adsorption beds operating out of phase to adsorb impurities within a feed stream to thereby produce a product stream. While one or more beds is adsorbing the impurities other beds are being regenerated through desorption of the impurities. For example, in pressure swing adsorption the feed stream under pressure is introduced into an adsorbent vessel to adsorb the impurities and thereby produce a product stream. Each such bed is regenerated by decreasing its pressure to thereby cause the impurities to desorb and then subjecting the bed to a purge with part of the product to further increase desorption of the impurities. The purge produces a purge stream that contains both the product sought to be purified and the impurities. Before being brought on line again, the bed is depressurized with the product. In another type of cycle, vacuum is also drawn to help regenerate the beds. In yet a further cycle, known as temperature swing adsorption, a swing in temperature is used in the regeneration of the beds.

As known in the art, in the control of such units, it is important that the cycle be conducted such that the impurity level of typically a single impurity in the product stream is controlled. Control units are provided by manufactures in which bed cycle time is adjusted to control the impurity level to be within a range that will ensure that a maximum impurity specification is not exceeded. The control of cycle time is typically with the use of a capacity factor that as will be described is inversely proportional to bed cycle time. The problem with the type of control as described above is that as the cycle time is increased, there exists a greater probability that the product stream will fail to meet specification. However, decreasing the cycle time will decrease the production of the product. Consequently, setting the cycle time or more commonly, setting the capacity factor, is critical in controlling any adsorption unit.

Hydrogen pressure swing adsorption units are utilized within hydrogen production facilities to purify a hydrogen containing feed stream from such impurities as nitrogen, carbon monoxide, methane and carbon monoxide. Such units employ adsorbent beds that operate in an out of phase cycle to adsorb the impurities. Each of the adsorbent beds typically will contain layers of adsorbents such as an initial layer of alumina, an intermediate layer of treated carbon and a further layer formed by a zeolite. In the production of hydrogen, it is required that the hydrogen product stream be produced in accordance with a specification in which there exists a maximum amount of carbon monoxide that is acceptable in the product and a minimum amount of carbon monoxide that will be acceptable. The control problem, as described above, is particularly problematical with respect to a hydrogen pressure swing adsorption application in that a hydrogen production facility in which such a unit is employed is normally designed to produce several different products with the use of concurrently operated units and therefore, the flow, composition, temperature and pressure of the feed stream to the pressure swing adsorption unit will vary. As known in the art, all of these factors will affect the performance of the unit and thus, the feed requires continual monitoring and adjustment of the capacity factor.

For example, in a hydrogen production facility, natural gas is used both as a reactant feed along with steam to a steam methane reformer and as a fuel for burners that support a very well known endothermic steam methane reforming reaction. Steam methane reforming produces a synthesis gas product that contains carbon monoxide, carbon dioxide and hydrogen. In subsequent unit operations, the synthesis gas is processed by an amine scrubbing unit to remove carbon dioxide. After carbon dioxide removal, carbon monoxide is separated in a cold box that employs distillation towers to produce a crude hydrogen stream. Additionally, part of the synthesis gas product from the steam methane reforming is subjected to a water gas shift reaction to produce a shifted gas stream containing more hydrogen through reaction of carbon monoxide and steam. The shifted stream is combined with the crude hydrogen stream. Moreover, some of the shifted gas along with synthesis gas, carbon dioxide and hydrogen can be processed in a methanol plant to make methanol. Some of the methanol can be further processed to make formaldehyde. A purge stream utilized in the methanol plant will contain unreacted hydrogen and unreacted carbon dioxide, carbon monoxide. The feed to the pressure swing adsorption unit in such a facility can therefore be made up of the crude hydrogen stream produced by the cold boxes, the shifted stream and the purge stream produced by the methanol plant. However, the demand for the hydrogen product can vary along with that of such subsidiary products as methanol. Further, as indicated above, there can be multiple units such as steam methane reformers, shift reactors and cold boxes that may not all be operating at the same time both in accordance with product demand and maintenance schedules. As such, the feed composition, temperature and flow rate will vary with the variable operation of the unit operations being conducted within the hydrogen producing facility.

In the prior art, as explained in U.S. Pat. No. 7,025,801, two types of control are commonly employed together in connection with pressure swing adsorption units. In one of such controls, the controller monitors the feed flow rate to the pressure swing adsorption unit. The higher the flow rate, the shorter the cycle time and vice-versa. At the same time, the purity of the hydrogen product stream is measured. If the purity of the product is below the specification, the cycle time is increased and vice-versa. However, the problem with the operation of such feed back controls is that there exists a lag between a control input and the intended results. In order to overcome this, the controller disclosed in this patent incorporates feed forward control by monitoring conditions in the feed to the pressure swing adsorption unit to in turn modify bed cycle time in accordance with pre-established signals representing predicted changes to the composition.

The problem with the control system utilized in the patent discussed above is that the control actions are limited by the pre-established conditions that the signals represent. As such, the controller cannot respond accurately to conditions that lie between the pre-established conditions. As will be discussed, the controller of the present invention incorporates connected feed forward and feed back levels of control that among other advantages, allows accurate control of the adsorption unit under any condition of the feed stream.

### SUMMARY OF THE INVENTION

The present invention provides a method of controlling an adsorption unit having adsorbent beds operating out of phase and at a cycle time to adsorb impurities within a feed stream, thereby to produce a product stream. The product stream contains a product and having a concentration of an impurity concentration that is no greater than that contained in a product specification and a control unit is also provided that is responsive to a manipulated variable to control the cycle time.

In accordance with the present invention, a control system is continually executed that has a feed forward level of control and a feed back level of control. During execution of the control system, feed stream data related to current physical properties of the feed stream that will effect the impurity concentration in the product stream is inputted along with product stream data referable to a current impurity concentration of the product stream and a current value of the manipulated variable. In this regard, the term, “related” as used herein and in the claims with respect to the feed stream data is not meant to limit the data to actual measurements and such data, when “related”, can be data from which specific parameters can be imputed or derived.

A probability is predicted in the feed forward level of control with a probability function responsive to the feed stream data and the current value of the manipulated variable that the impurity concentration of a specific impurity will be greater than a pre-specified concentration within the product specification. If the probability is greater than a maximum allowable probability, an optimal value of the manipulated variable is calculated utilizing the feed stream data and the maximum allowable probability within the probability function.

The current impurity concentration of the specific impurity is compared with a predetermined, allowable impurity range that will prevent the pre-specified concentration from being exceeded. The manipulated variable is updated with the optimal value of the manipulated variable within the control unit if the current impurity concentration of the specific is below the predetermined, allowable impurity range or is within the predetermined, allowable impurity range but has a magnitude that will result in a shorter cycle time than the current value of the manipulated variable. The value of the manipulated variable is left unchanged within the control unit if the current impurity concentration of the specific impurity is within the predetermined, allowable impurity range but the optimal value would result in a longer cycle time than the current value of the manipulated variable.

However, if the current impurity concentration of the specific impurity is above the predetermined, allowable impurity range, the optimal value is adjusted by varying the optimal value in an amount determined by the feed back level of control to return the impurity concentration of the specific impurity to a level that is within the predetermined, allowable impurity range. The manipulated variable is then updated with the optimal value after adjustment within the control unit.

The optimal value of the manipulated variable is adjusted in the feed back level of control by calculating a rate of change of the impurity concentration of the specific impurity within the product stream and utilizing fuzzy logic having functionality responsive to the rate of change and the current impurity concentration of the specific impurity in the product stream. The fuzzy logic employs a rule set configured such that as at least one of the rate of change and the current impurity concentration of the specific impurity increases, the variation imparted to the optimal value of the manipulated variable will reduce the cycle time.

As can be appreciated, in a method in accordance with the present invention, since the manipulated variable is first being optimized on the basis of probability with the end result that the shortest cycle time will be used as the optimal, production is thereby optimized for the greatest recovery. If, the concentration of the impurity is above a targeted range, the further variation or adjustment of the optimal manipulated variable will result in a reduction of the cycle time in a sufficient amount to return the impurity concentration to the targeted range and as such, the production is optimized as much as is practical. Such method, unlike the prior art, allows for cycle time adjustment at any condition of the feed stream. Although the invention, as recited above, only specifically recites a control method that relates to a specific impurity, it is understood that, as will be discussed hereinafter, the present invention is not meant to be limited by such recitation and is intended to cover the control of multiple impurities.

The manipulated variable can be a capacity factor equal to a product of a design cycle time and design flow rate of the feed stream divided by a product of a current value of the flow rate of the feed stream and a value of the cycle time that is in use by the control unit. As such, the current value of the manipulated variable is a current capacity factor having a current value of the cycle time in use by the control unit and the optimal value of the manipulated variable is an optimal capacity factor having an optimized value of the cycle time calculated as a result of a solution of the probability function. It is to be noted that other manipulated variables related to cycle time are used by manufacturers of adsorption units. For example, the reciprocal of the capacity factor defined above is sometimes used. Also, the manipulated variable may be directly representative of the cycle time.

An amount of change of the capacity factor produced as a result of execution of the control system can be limited by a limiting factor. In such case, either the optimal capacity factor after adjustment or a sum of the current capacity factor and the limiting factor is used within the control unit, which ever is less.

In any embodiment of the present invention, the probability function can be a binary logistic regression model.

The adsorption unit can be a pressure swing adsorption unit, the product stream can be a hydrogen product stream containing hydrogen and the specific impurity can be carbon monoxide. Further, the feed stream data can comprise data representing the hydrogen, the carbon monoxide, methane, carbon dioxide and nitrogen concentrations present in the feed stream and also, in a tail gas stream, a product flow rate of the hydrogen product stream and a measured flow rate of the feed stream. An imputed flow rate of the feed stream is utilized in the probability function.

The imputed flow rate is calculated by scaling the data representing concentrations of the hydrogen, the carbon monoxide, methane, carbon dioxide and nitrogen so that the concentrations add up to 100 percent and are thereby scaled concentrations. A current recovery percentage of the hydrogen is then determined by determining a difference of the scaled concentrations between the hydrogen in the feed stream and the tail gas stream and dividing the difference with a quantity equal to a scaled concentration of the hydrogen in the tail gas stream subtracted from one and multiplying such quantity by the further scaled concentration of the hydrogen in the feed stream. The imputed flow rate of the feed stream is then determined by dividing the product flow rate of the hydrogen product stream by a product of the current recovery percentage and the current further scaled concentration of the hydrogen in the feed stream.

Further, the performance of the adsorption unit can be affected when a temperature of the feed stream is below a specific temperature. As such, the feed stream data can also include temperature data related to the temperature of the feed stream and the optimal capacity factor is also adjusted within the feed forward level of control, when the temperature is below the specific temperature, by subtracting from the optimal capacity factor a value equal to a product of a constant and a difference between the temperature of the feed stream and the specific temperature.

In case of a hydrogen application of the present invention, current bed loadings are calculated for methane, carbon dioxide and carbon monoxide present within the feed stream with the use of the feed stream data, the imputed flow rate of the feed stream and a cycle time either inputted into the control system as additional data or derived from the data related to the measured flow rate and the current capacity factor. Current loading ratios are calculated for each of the impurities within the feed stream with the use of predetermined design bed loadings and the design bed loadings are utilized within the probability function. Also, the optimal capacity factor can be determined by solving the probability function for an optimal cycle time and then calculating the optimal capacity factor with the use of the optimal cycle time and the measured flow rate of the feed stream.

The feed stream data also includes raw data of raw concentrations of the hydrogen, the carbon monoxide, the methane, the carbon dioxide and the nitrogen present in the feed stream, a sum of the raw concentrations is compared with a predetermined tolerance and if the sum exceeds the tolerance, the data referable to the current flow rate and the current concentration of the feed stream is determined from the flow rates of product streams emanating from unit operations that are combined to form the feed stream along with assumed compositions of such product streams.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a general plant schematic of a hydrogen production facility in which a control method in accordance with the present invention is employed;

FIG. 2 is a schematic of a control system for carrying out a method in accordance with the present invention;

FIG. 3 is a logic diagram of the steps involved in performing a control method in accordance with the present invention;

FIG. 4 is a logic diagram of the feed back control system employed in FIG. 1;

FIG. 5 is an example of an input fuzzy function used to convert values representing the carbon monoxide concentration in a hydrogen product stream to fuzzy values;

FIG. 6 is an example of an input fuzzy function used to convert values representing the rate of change of carbon monoxide in a hydrogen product stream to fuzzy values; and

FIG. 7 is an example of an output fuzzy function that is used to convert the linguistic values of a rule set to a capacity factor difference.

### DETAILED DESCRIPTION

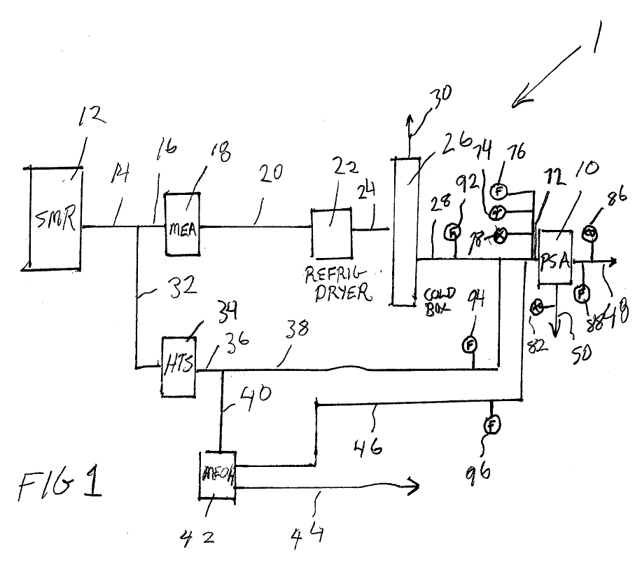

With reference to FIG. 1 a hydrogen production facility 1 is illustrated as an environment for controlling a pressure swing adsorption unit 10. It is understood, however, that this is for exemplary purposes only and the present invention has application to an adsorption unit in which beds of adsorbent are operated in an out of phase cycle to adsorb impurities within the feed stream to produce a product stream and to allow for regeneration of the beds. The present invention is also not limited to the particular environment imposed by facility 1, in that pressure swing adsorption units that are employed in different environments. In the following description of the present invention, an example of the calculations will be set forth to illustrate the operational aspects of the method in accordance with the present invention. However, it is understood that the invention is also in no way intended to be limiting.

Hydrogen production facility 1 is provided with a steam methane reformer 12 that produces a synthesis gas stream 14. One part of the synthesis gas stream designated by reference numeral 16 is introduced into an amine scrubbing unit 18 (MEA) of known design in which the synthesis gas is scrubbed in an adsorption column with monoethanolamine. The solvent, which is rich in carbon dioxide, is regenerated in a stripper column with steam to produce a purified carbon dioxide which can be discharged and used for other purposes or sequestered. The resultant scrubbed stream 20 is introduced into a compressor (not illustrated) and is then introduced into a refrigeration and drying unit in which compressed stream 20 is cooled and water is condensed out of the stream. The resultant dry feed stream 24 is introduced into a cold box 26. Cold box 26 can take the form of any of a variety of known designs that by distillation produce a crude hydrogen stream 28 and a carbon monoxide-rich stream 30 that can be taken as a product. Additionally, although not illustrated, a tail gas stream is generated that can be used in the firing of the steam methane reformer 12.

Another part of the synthesis gas stream 14, designated by reference numeral 32, is introduced into a high temperature shift reactor 34 in which the stream is subjected to water gas shift reactions to produce additional hydrogen by reaction of steam with carbon dioxide. This results in a shifted stream 36. One part of the shifted stream 36, designated by reference numeral 38, is combined with crude hydrogen stream 28 to form part of the feed to the pressure swing adsorption unit 10. Another part of the shifted stream 36 designated by reference numeral 40 is introduced into the methanol plant 42 (“MEOH”) that produces methanol. A methanol product stream 44 can be sent to storage. As known in the art part of the methanol process stream 44 may be obtained from storage and used to produce formaldehyde. A purge stream 46 is produced from the methanol plant 42 that contains hydrogen, unreacted carbon dioxide, carbon monoxide, steam and etc. Tail gas stream 46 is combined with crude hydrogen stream 28 and part 38 of shifted stream 36 to form a feed stream 72 to pressure swing adsorption unit 10.

Pressure swing adsorption unit 10 produces a hydrogen product stream 48 and a tail gas stream 50. Tail gas stream 50 can also be used as part of the fuel for firing steam methane reformer 12. Pressure swing adsorption unit 10 can be provided with a plurality of beds, for example, nine beds, that operate out of phase such that some of the beds are absorbing to produce the hydrogen product stream 48 while other of the beds are desorbing and being regenerated. As described above, in regenerating a bed, a tail gas stream 50 is produced.

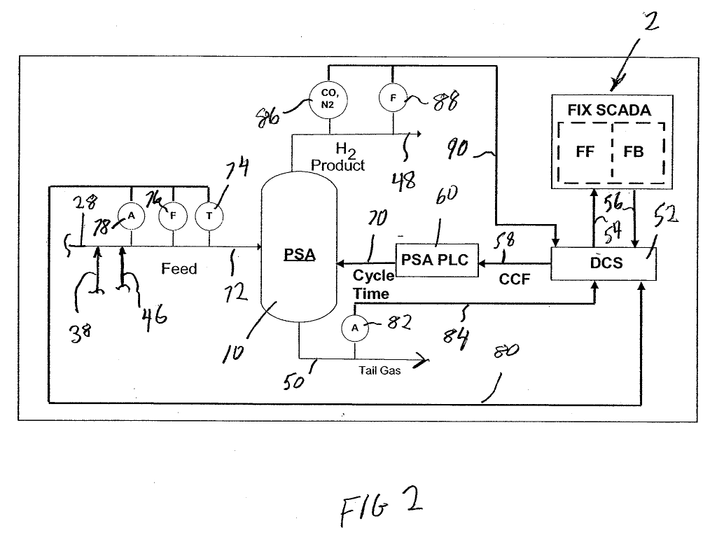

With reference to FIG. 2, a control system 2 is illustrated for carrying out a method in accordance with the present invention. Briefly, the control system 2 receives data that is stored in a supervisory control and data acquisition system (“SCADA”) and has two levels of control namely a feed forward level of control (“FF”) and a feed back level of control (“FB”). Data from the distributed control system (“DCS”) 52 is input into the supervisory control and data acquisition system as generally indicated by arrowhead 54. As a result of processing that will be discussed, a capacity factor 56 is returned to the distributed control system 52 and is inputted, as indicated by arrowhead 58, into a pressure swing adsorption control system 60 (“PSA PLC”). From pressure swing adsorption control system 60, a control signal 70 generated that in a manner known in the art controls the cycle time in which each bed of the pressure swing adsorption unit 10 is adsorbing purities within a feed stream 72 through the pressure swing adsorption unit 10. As well known in the art, the pressure swing adsorption control system 60 and its manner of control are provided by manufacturers of such units are well known in the art.

For purposes that will be discussed, data that consists of the temperature flow and composition of feed stream 72 is generated by temperature transducer 74, flow meter 76 and mass spectrometer 78. The resultant data as generally indicated by reference numeral 80 serves as an input to distributed control system 52. Additionally, a mass spectrometer 82 is provided to measure the composition of tail gas stream 50. Data, as generally indicated by reference numeral 84, also serves as an input to a distributed control system 52. Likewise, the mass spectrometer 86 and a flow meter 88 are provided to measure in particular, the carbon monoxide concentration within the hydrogen product stream 48 and as well as its flow. The resulting data, as generally indicated by reference numeral 90, also serves as an input to a distributed control system 52. All of the aforesaid data is introduced as indicated by reference numeral 54 into the supervisory control and data acquisition system and serves as an input into control system 2. As will be discussed, the capacity factor that is fed into the pressure swing adsorption control system 60 is computed by the control system 2 to produce a cycle time that will ensure the carbon monoxide content within hydrogen product stream 48 is in a range which for exemplary purposes is between about 0.25 ppm and 0.4 ppm.

Although not illustrated in FIG. 2 but as would be known to those skilled in the art, flow of crude hydrogen stream 28, the flow of part 38 of shifted stream 36 and the tail gas stream 46 produced by methanol plant 42 are also fed as inputs into the distributed control system 52 and for purposes that will be discussed, are also fed into the control system 2. With brief reference to FIG. 1, the data representative of the flow rates of such streams is gathered by flow meters 92, 94 and 96.

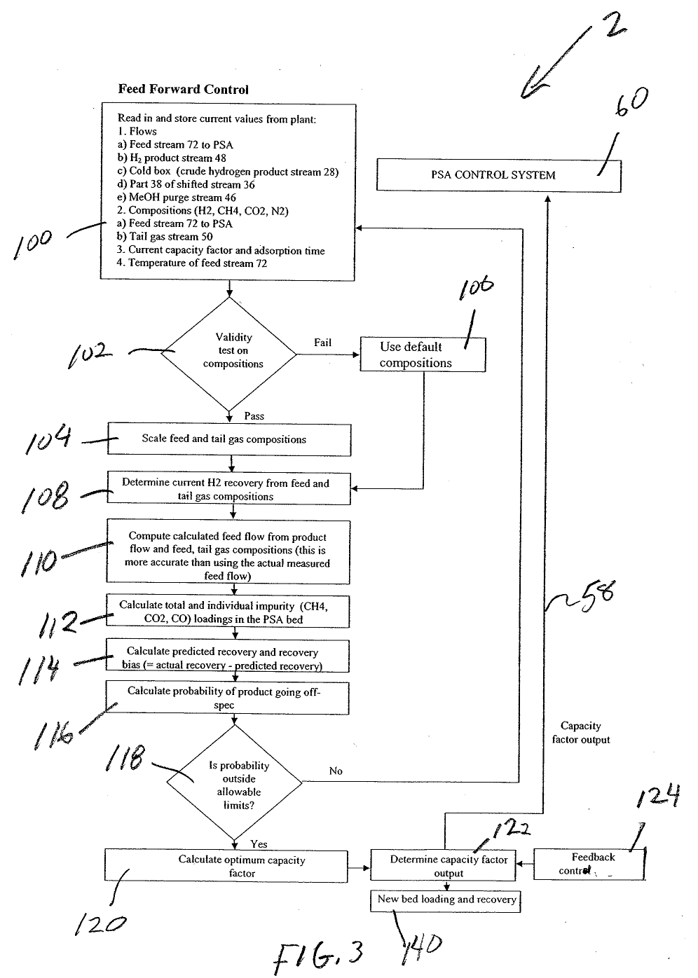

With reference to FIG. 3, a logic flow diagram is illustrated for the processing that takes place within control system 2. As indicated by logic block 100, current values are input from the plant that originate in distributed control system 52 and that are recorded in the supervisory control and data acquisition system. For exemplary purposes, the following Table 1 is a listing of the compositions in percent and on a volume basis of the feed stream 72 and the tail gas stream as gathered by spectrometers 78 and 82, respectively.

TABLE 1

| Feed Stream 72 | |
|---|---|
| (Component) | Composition |
| H₂ | 80.61 |
| CO | 2.65 |
| CH₄ | 4.74 |
| CO₂ | 11.76 |
| N₂ | 0.11 |

In addition to the compositions, the current value of the capacity factor is 0.825 and the cycle time is 212. In this regard capacity factor is equal to a ratio of a product of a design volumetric flow rate to a bed and the design cycle time to a product of the actual flow rate to a bed and the current cycle time. Consequently, if the flow rate of the feed stream 72 to the pressure swing adsorption unit 10 is known along with the current capacity factor being utilized by the pressure swing adsorption control system 60, the current cycle time is also known. It is to be noted that the term “design” as used herein and the claims means a quantity or quantities that is utilized by the manufacturer in designing a pressure swing adsorption unit, such as unit 10, that utilize assumed flow rates and compositions of a feed stream, a product stream and a tail gas stream, assumed bed loadings and an assumed bed cycle time during which a bed is adsorbing impurities to produce the product stream. One last point is that the feed stream data that is inputted can be any data that has a bearing on the impurity level in the product stream and as such for a different type of cycle, for example temperature swing, other or addition physical characteristics of the process streams might be important in this regard.

For purposes of the running example, the temperature of the feed stream 72, as measured by temperature transducer 74 is 75° F., and the flow rate of the hydrogen product stream 48 as measured by flow meter 88 is 3162.10 mcfh. Although not set forth in the example, the flow rates of the feed stream 24, the crude hydrogen stream 28, the part 38 of the shifted stream 36 and the methanol plant purge stream 46 are also recorded.

As indicated in logic block 102, the validity of the composition measurements on both the feed stream 72 and the tail gas stream 50 is tested to make certain that the total for each of the streams adds up to 100 percent plus or minus a tolerance, which for exemplary purposes is 5 percent and that each of the components measured is also within a tolerance given for each of the components. The reason why this is done is to make certain that the mass spectrometers used in gathering the related data are properly functioning. The following Table 2 illustrates the tolerances to be applied. The tolerances set forth in this table are derived through experience in the use of the actual mass spectrometers used in making the measurements.

TABLE 2
Composition Tolerance

| | | Tail Gas | | |
|---|---|---|---|---|
| | | Stream | | |
| Min | Max | 50 | Min | Max |

| | | | | | | |
|---|---|---|---|---|---|---|
| Feed Stream 72 | Total | 95 | 105 | Total | 95 | 105 |
| | H₂ | 70 | 100 | H₂ | 20 | 60 |
| | N₂ | 0 | 5 | N₂ | 0 | 5 |
| | CO | 0 | 10 | CO | 0 | 20 |
| | CH₄ | 2 | 10 | CH₄ | 2 | 20 |
| | CO₂ | 2 | 20 | CO₂ | 20 | 60 |

Turing back to table 1, it can be seen that the sum of the components for the feed stream is 99.98 percent and the sum of the components for the tail gas stream 50 adds up to 100.02 percent. Both of the totals are within the allowable tolerance of 5 percent. In addition, if each of the components is inspected, it can also be seen that each component is within its tolerance. Consequently, the validity test on compositions has been passed.

Assuming that the test of block 102 is passed, as indicated in box 104, the feed stream 72 and tail gas stream 50 compositions are scaled that they each add up to 100 percent. The result of such scaling is given in Table 3, below.

TABLE 3

| Feed Stream 72 | Tail Gas Stream 50 |
|---|---|
| Scaled Compositions | Scaled Compositions |
| H₂ - 80.73% | H₂ - 40.03% |
| CO - 2.65% | CO - 7.89% |
| CH₄ - 4.74% | CH₄ - 14.73% |
| CO₂ - 11.76% | CO₂ - 36.98% |
| N₂ - 0.11% | N₂ - 0.37% |

Assuming that the test in logic block 102 had failed, then as indicated in logic block 106, default compositions would have been used. These default compositions are determined by assuming the concentration of crude hydrogen stream 28, part 38 of shifted stream 36 and purge stream 46 and with their measured flow rates, as measured by flow meters 92, 94 and 96, the percentage compositions to be assumed for feed stream 72 would be calculated. Although not illustrated, part of the hydrogen product stream 48 could be flared and in such case, the default compositions would also be used in the calculations to be discussed that require an accurate measurement of the flow rate of the hydrogen product stream 48.

After the compositions of the feed stream 72 are determined either by scaling the actual readings or from assumptions as described above, as indicated in logic block 108, the current hydrogen recovery within hydrogen product stream 48 is determined by the composition of the feed stream 72 and tail gas composition of tail gas 50 as indicated in logic block 108. The actual recovery is determined by subtracting the percentage composition of hydrogen in tail gas stream 50 from the percentage composition of the hydrogen in feed stream 72 and dividing the difference by a product of a quantity of one minus the hydrogen percentage in the tail gas stream and the hydrogen percentage in the feed stream 72. In the current example, Actual Recovery=(0.8073−0.4003)/((1−0.4003)*0.8073)=84.07%.

The actual recovery is used to impute a feed flow for feed stream 72 from the product flow of hydrogen product stream 48 and the feed and tail gas compositions of feed stream 72 and tail gas 50 as indicated in logic block 110. In this particular installation, these values associated with the relevant data are more accurate than using the actual measured feed flow of feed stream 72. However, it is possible that the raw data value of the flow of the feed stream 72 could be used if it were assured that the feed flow measurements of feed stream 72 were accurate. This calculation is equal to the flow rate of the hydrogen stream 48 divided by a product of the percentage hydrogen composition of the feed stream 72 and the hydrogen recovery calculated in logic block 108. Thus, in the current example, the flow rate of the feed stream 72=3163.1/(0.8073*0.8407)=4660.7 mcfh.

The total and individual impurity loadings in a bed employed within pressure swing adsorption unit 10 is then calculated in next logic block 112. Bed loading is equal to a product of feed flow rate and the bed cycle time in seconds divided by 3600. With respect to an impurity component of interest, the loading is further multiplied by the percentage composition of the impurity within the feed stream. The loadings are compared with design loadings for the pressure swing adsorption unit 10 as a ratio that will be used in later calculations. For purposes of the example, Table 4 below is the design bed loadings L, and Table 5 sets forth the current computed loadings and the ratio between the current computed loadings and the design bed loadings.

TABLE 4

| Component | L_{C,DESIGN} |
|---|---|
| H₂ | 157.85 |
| CO | 7.43 |
| CH₄ | 12.84 |
| CO₂ | 33.86 |

TABLE 5

| Current Loadings (Lₙ) | mcf/cycle |
|---|---|
| Total, L_{T},_{CURRENT} | 274.5 |
| H₂, L_{H2},_{CURRENT} | 221.6 |
| CO, L_{CO},_{CURRENT} | 7.3 |
| CH₄, L_{CH4,CURRENT} | 13.0 |
| CO₂, L_{CO2},_{CURRENT} | 32.3 |
| Current Loading Ratios (Rₙ) | Loading Ratio |
| H₂, R_{H2},_{CURRENT} | 1.40 |
| CO, R_{CO},_{CURRENT} | 0.98 |
| CH₄, R_{CH4,CURRENT} | 1.01 |
| CO₂, R_{CO2,CURRENT} | 0.95 |

The loadings that are determined in block 112 are then used in logic block 114 to calculate a predicted recovery and a recovery bias. The predicted recovery utilizes an equation having coefficients that are determined by data regression and is given by the following expression: A+B*L_{T, Current}+C*L_{T, Current}, where for purposes of the example, the coefficients give by A-14.8243; B=0.558016 and C=−0.001043. If this equation is applied to the total loading calculated in logic block 110, the result is equal to 89.4. The bias is simply the difference between the predicted recovery and the actual recovery computed in logic block 108 or 84.07−89.4=−5.33.

A probability is then determined in logic block 116 whether the hydrogen product stream 48 will be outside of specification or in other words will contain a level of carbon monoxide that is above a pre-specified concentration. When the level of carbon monoxide within hydrogen product stream 48 is greater than such concentration, the product is “off-spec”. This probability is determined from the loading ratios of the impurities by probabilistic equations having coefficients determined by data regression. The actual equations used are known as binary logistic regression equations and are as follows: X=a+b*R_{C,CO,CURRENT}+c*R_{C,CH4,CURRENT}+d*R_{C,CO2,CURRENT}; and Probability=100%−[e^{x}/(1+e^{X})]*100%. Another possible type of equation that could be used is a binomial distribution function. The coefficients in the first equation for “X” are determined through regression and for purposes of the example are: a=18.1987; b=−11.3158; c=−4.6613 and d=−3.8714. When the loading ratios are entered into this equation, “X” is found to equal −1.298. When X is in turn entered into the second equation, the probability is 78 percent that is greater than an allowable probability of 35 percent.

It is to be noted that for purposes of computing the probability and the optimal capacity factor as set forth below, the probability functions are responsive to an imputed flow rate of feed stream 72. If an actual, measured flow rate for such stream were available, such flow rate could be used. In addition, although nitrogen is present in the stream it is not used in the probability function. The reason for this is that in the particular facility, the nitrogen measurements have not been found to be accurate and their lack of presence within the calculations has not been found to be detrimental. In a proper case, the nitrogen concentration could in fact be used as described below. As such, only the current impurity bed loadings would be used. Further, it is possible to not use bed loadings at all and instead design the data-regressed equations to use values related to flow rate and the usable impurity concentrations. In fact, give that design conditions are constant, it can be said that the equation above is in reality responsive to the current flow rate, usable impurity concentrations and current capacity factor.

As indicated in logic block 118, the probability is tested and if the probability were less than 35 percent, then the execution of the control system 2 would loop back to data block 100. For purposes of the example, the probability is outside of the limits and therefore, an optimum capacity factor is calculated as illustrated by data block 122.

The optimum capacity factor is the smallest possible that will not be likely to exceed the probability limit, which for purposes of the example is 35 percent. Therefore, if a probability of 35 percent is assumed, the equations used in logic block 116 can provide the optimum capacity factor under current conditions. For exemplary purposes an optimal value of X is solved for by entering 35 percent into the probability equation as follows: X_{OPT}=ln [(1−35/100)/(35/100)]=0.61. Then the equation that has the regression constants is solved for an optimal cycle time “tₒₚₜ” as follows: t_{ADS,OPT}=[X_{OPT}−a]*3600/[F_{IN,CALC}*(b*X_{F,CO,SCALED}/L_{C,CO,DES}+c*X_{F,CH4,SCALED}/L_{C,CH4,DES}+d*X_{F,CO2,SCALED}/L_{C,CO2,DES})]=191.2.

The optimal capacity factor is simply determined as indicated above using a ratio of a product of the design bed cycle time and the design flow rate divided by a product of the actual flow rate and the optimal cycle time. In the example, the optimal capacity factor is equal to (172*4468.5)/4731.36*191.2)=0.85. It is to be noted that for purposes of this equation, the raw flow measured by flow meter 76 is used rather than the flow calculated in data block 110 given the fact that the pressure swing adsorption control system uses such actual flow rate.

The effect of feed temperature is then added to the optimal capacity factor as may be necessary given the temperature of feed stream 72 sensed by temperature transducer 74. For pressure swing adsorption unit 10, functioning in the given environment, it has been found that if the temperature is above about 80° F. there will be no effect on such unit in its processing of impurities such as carbon monoxide. Below this temperature there will be an effect. This effect is compensated for, if at all, by an equation in which the optimal capacity factor is equal to the optimal capacity factor determined on the basis of the probability equations less a constant multiplied by the difference in temperature between the temperature of feed stream 72 and 80° F. for purposes of the example. The constant is determined by data regression and its value for exemplary purposes is 0.2. Hence, given the fact that the temperature of feed stream 72 is below 80° F. and is in fact 75° F., the forgoing relationship is used to determine an optimal capacity factor of 0.86. It is understood, however, that in certain pressure swing adsorption units, operation is best conducted within a specific range. In such case, appropriate compensation would be provided for actual operational conditions outside of such range.

As indicated in logic block 122 a capacity factor is determined that serves as an input generally indicated by reference numeral 58 to pressure swing adsorption control system 60. Assuming that carbon monoxide as measured by mass spectrometer 78 within product stream is below the range of 0.25 ppm to 0.4 ppm, then the capacity factor that is transmitted to pressure swing adsorption system 60 is the optimal capacity factor determined in accordance with the method set forth above or 0.86. If the carbon monoxide is within such range and the optimal capacity factor is greater than the current capacity factor, then the capacity factor being utilized by pressure swing adsorption system 60 is updated with the optimal capacity factor. In the running example, since the optimal capacity factor is 0.86 which is greater than the current capacity factor of 0.835, the capacity factor would be updated. If, however the optimal capacity factor is less than the current capacity factor, then the capacity factor presently being utilized by pressure swing adsorption system 60 is left unchanged and is not updated with the new capacity factor in that a lower capacity factor would produce a greater cycle time and a greater probability of the product going off-spec.

Another possibility is that the carbon monoxide concentration is already beyond the allowable targeted range of carbon monoxide concentration. In such case, the feed back level of control is invoked as indicated in block 124 to increase the optimal capacity factor such that the bed cycle time will be reduced and the concentration of carbon monoxide within hydrogen product stream 48 will be reduced. This is preferably done with fuzzy logic. It is to be noted that since maintenance of allowable carbon monoxide concentration within the hydrogen product stream is paramount, the feed back level of control executes with a greater frequency than the feed forward level of control. With reference to FIG. 4, the feed back level control is illustrated. The first step is to input the current carbon monoxide concentration within the hydrogen product stream 48 as indicated in logic block 126. A rate of change of the carbon monoxide concentration in the product stream is then determined from past values regarded as a result of execution of the feed back level of control.

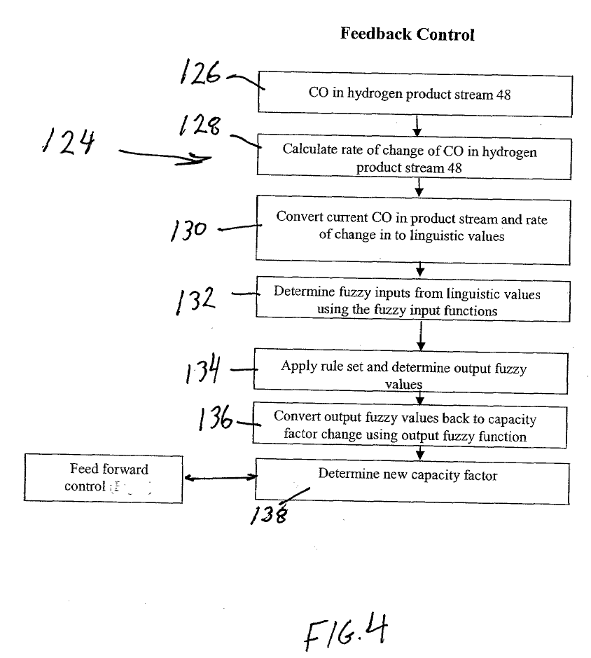

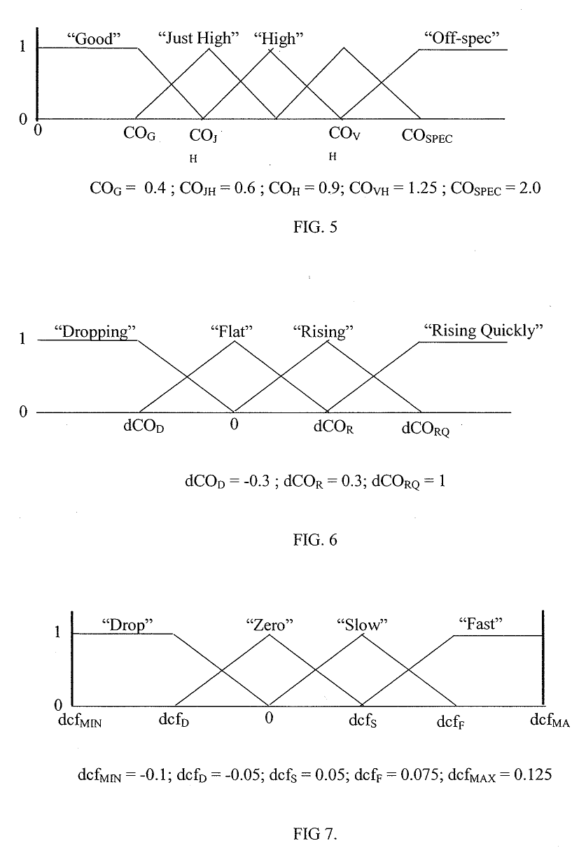

As set forth in block 130, the numerical values for the current carbon monoxide concentration and the rate of change in the carbon monoxide are converted into linguistic values. This is called fuzzifing the inputs. The carbon monoxide content in product is converted into five possible values (“off-spec”, “very high”, “high”, “just high”, “good”) and the rate of change in the carbon monoxide is also converted into four possible values (“dropping”, “zero”, “rising”, “rising quickly”). FIGS. 5 and 6 show the “fuzzy sets” used in this process. Each of the input values is described by its membership in each of these sets. For instance, if the carbon monoxide is currently 0.5 ppm, then that would be described as 50 percent “good” and 50 percent “just high”. In a standard notation this would be shown as (0.5, “good”) and (0.5, “very high”). The same procedure is then carried out for the rate of change in the carbon monoxide concentration.

Next, as indicated in block 134, the rule set or sets that make up the expert system component of the controller are applied using the two inputs to the system which were either inputted in linguistic values, or have been converted to linguistic values. These rules are derived from knowledge of the system and simple common sense. Table 6 is a rule set to be applied for exemplary purposes. As is apparent, the rule set is designed such that as the concentration of carbon monoxide is rising or rising quickly or the carbon monoxide concentration is drifting from high to off spec, the capacity factor will be greater or in other words the cycle time will decrease.

TABLE 6

| | | CO | | | | |
|---|---|---|---|---|---|---|
| | | | Just | | Very | Off |
| | | Good | High | High | High | Spec |
| dCO | Dropping | Z | D | D | Z | Z |
| | Flat | Z | Z | S | S | S |
| | Rising | Z | S | S | F | F |
| | Rising | Z | F | F | F | F |
| | Quickly | | | | | |

The carbon monoxide concentration and the rate of change in the carbon monoxide concentration (dCO) are combined to produce the output value (M1). The value M1 is described using 4 fuzzy sets, “drop”, “zero”, “slow”, “fast”. The calculations involve determining the applicability of each of the rules in Table 6 given the fuzzy set memberships of the inputs. For illustration, assume that the carbon monoxide concentration in the hydrogen product stream is (0.5, “good”) and (0.5, “just high”), and the rate of change of the carbon monoxide concentration is (0.5, “flat”) and (0.5, “rising”). Upon an inspection of Table 6, if the carbon monoxide is “good” and rate of change in the carbon monoxide (dCO) is “flat”, the output value M1 is “zero”. The applicability of the rule needs to be quantified. This is accomplished by taking the intersection of the two fuzzy sets “carbon monoxide is good” and “change in carbon monoxide is flat”. The intersection is defined as the minimum of their respective memberships. In this case, that value is 0.5. In a similar way, other rules are all calculated to have an applicability of 0.5. These values are then normalized to 1 for the sake of simplicity.

Once the applicable rules are determined and their degree quantified, the output from this rule set (M1) can be characterized. Each of the rules listed give a linguistic value for M1. For instance, rule 1, rule 2 (“carbon monoxide is good” and dCO is “rising”) and rule 3 (“Carbon monoxide is just high” and dCO is “flat”) state that M1 should be “zero”, and rule 4 (“Carbon monoxide is just high” and dCO is “rising”) states “slow”. The characterization of M1 is simply the sum of the applicability of the rules which dictate a certain fuzzy set. In this case, M1 would be (0.75, “zero”), (0.25, “slow”).

Now that the final output of the controller has been described linguistically, it needs to be converted back to a numerical value. This is called defuzzifing the output. FIG. 7 shows the fuzzy sets used to describe the output. Note that once again there are no numbers presented on this figure since they will vary by the application.

The output is converted to a numerical value using the common and simple center-of-gravity approach. In that approach the center of gravity of each of the membership sets is determined. The numerical value of the output is then the sum of the centers of gravity multiplied by the membership in that set. In this example, the centers of gravity are 0 for “zero”, and 0.05 for “slow”. The weighted sum of the center of gravities is calculated as: (0.75)(0)+(0.25)(0.05)=0.0125. Therefore, the change in the optimal capacity factor is 0.0125/hour.

A new capacity factor is then determined as set forth in block 138 by taking either the current capacity factor or the optimum capacity factor, which ever is greater and then adding to it a product of the change in the optimal capacity factor and the frequency at which the feed back level of control executes. The resulting adjusted optimum capacity factor is sent back to block 122 as determined in FIG. 3.

Returning to FIG. 2, before any optimal capacity factor is fed back to the pressure swing adsorption system controller 60, it is preferable to limit the change in bed cycle time that would result from a newly calculated capacity factor. This is done by adding to the current capacity factor an allowable change and utilizing the current capacity factor with the allowable change as an updated capacity factor or by utilizing the capacity factor as computed above, which ever is less. For example, an allowable change in capacity factor might be set equal to 0.1. In the example, the updated value of the capacity factor that would be sent to pressure swing adsorption control system 60 would be 0.845 rather than the optimal capacity factor of 0.86 computed in the manner above.

Turning back to FIG. 3, a new bed loading and recovery can also computed for display to operational personnel as indicated in logic block 140. In order to do this, with the use of the optimal capacity factor, calculated either in the feed forward level of control or the feed back level of control, which ever is used, and the flow rate of the feed stream 72, a new bed cycle time is computed. From the new bed cycle time, a new total loading is computed with the use of the calculated flow rate and the new bed cycle time divided by 3600. A new recovery is then computed from the recovery equation used in logic block 114 with the use of the new total loading and the bias computed in logic block 114 is then added to the result.

As indicated above, the present invention has application to the control of multiple impurities. In such case, a probability function would be provided for each of the impurities and if the calculated probability were greater than a maximum allowable probability, then an optimal capacity factor or other relevant manipulated variable could be calculated for such impurity. The current concentration of such impurity would then be compared with a predetermined allowable impurity range for such impurity and a potential optimal capacity factor for such impurity would then be selected as described above. When potential optimal capacity factors were developed for all impurities of interest, the potential optimal capacity factor that gave rise to the longest cycle time would then be used as the optimal capacity factor. Fuzzy input and output sets and rule sets for each of the impurities could also be provided. If the concentration of any impurity were above its targeted range, then the optimal capacity factor would be further adjusted by the input and output sets and rule set applicable to such impurity to return the impurity to the targeted range.

While the present invention has been described with reference to a preferred embodiment, as will occur to those skilled in the art, numerous changes, additions and omissions may be made without departing from the spirit and scope of the invention as set forth in the appended claims.

We claim:

1. A method of controlling an adsorption unit having adsorbent beds operating out of phase and at a cycle time to adsorb impurities within a feed stream, thereby to produce a product stream containing a product and having an impurity concentration that is no greater than that contained in a product specification and a control unit responsive to a manipulated variable to control the cycle time, said method comprising:
continually executing a control system having a feed forward level of control and a feed back level of control;
during execution of the control system, inputting feed stream data related to current physical properties of the feed stream that will effect the impurity concentration in the product stream, product stream data referable a current impurity concentration within the product stream and a current value of the manipulated variable;
predicting a probability in the feed forward level of control with a probability function responsive to the feed stream data and the current value of the manipulated variable that the impurity concentration of a specific impurity will be greater than a pre-specified concentration within the product specification and if the probability is greater than a maximum allowable probability, calculating an optimal value for the manipulated variable utilizing the feed stream data and the maximum allowable probability within the probability function;
comparing the current impurity concentration of the specific impurity with a predetermined, allowable impurity range that will prevent the pre-specified concentration from being exceeded;
updating the manipulated variable with the optimal value of the manipulated variable within the control unit if the current impurity concentration of the specific impurity is below the predetermined allowable impurity range or is within the predetermined allowable impurity range but has a magnitude that will result in a shorter cycle time than the current value of the manipulated variable;
leaving the current value of the manipulated variable unchanged within the control unit if the current impurity concentration of the specific impurity is within the predetermined allowable impurity range but the optimal value would result in a longer cycle time than the current value of the manipulated variable; and
adjusting the optimal value if the current impurity concentration of the specific impurity is above the predetermined range, by varying the optimal value in an amount determined by the feed back level of control that will sufficiently reduce the cycle time to return the impurity concentration of the specific impurity to a level that is within the predetermined range and updating the manipulated variable with the optimal value after adjustment within the control unit;
the optimal value of the manipulated variable being adjusted in the feed back level of control by calculating a rate of change of the impurity concentration of the specific impurity within the product stream and utilizing fuzzy logic having functionality responsive to the rate of change and the current impurity concentration of the specific impurity in the product stream, the fuzzy logic employing a rule set configured such that as at least one of the rate of change and the current impurity concentration of the specific impurity increases, the variation imparted to the optimal value of the manipulated variable will reduce the cycle time.

2. The method of claim 1, wherein:
the manipulated variable is a capacity factor equal to a product of a design cycle time and design flow rate of the feed stream divided by a product of a current value of the flow rate of the feed stream and a value of the cycle time that is in use by the control unit;
the current value of the manipulated variable is a current capacity factor having a current value of the cycle time in use by the control unit; and
the optimal value of the manipulated variable is an optimal capacity factor having an optimized value of the cycle time calculated as a result of a solution of the probability function.

3. The method of claim 2, wherein an amount of change of the capacity factor produced as a result of execution of the control system is limited by a limiting factor and either the optimal capacity factor after adjustment or a sum of the current capacity factor and the limiting factor is used within the control unit, which ever is less.

4. The method of claim 2 or claim 3, wherein the probability function is a binary logistic regression model.

5. The method of claim 4 wherein:
the adsorption unit is a pressure swing adsorption unit;
product stream is a hydrogen product stream containing hydrogen;
the specific impurity is carbon monoxide;
the feed stream data comprises data representing the hydrogen, the carbon monoxide, methane, carbon dioxide and nitrogen concentrations present in the feed stream and also, in a tail gas stream, a product flow rate of the hydrogen product stream and a measured flow rate of the feed stream; and
an imputed flow rate of the feed stream is utilized in the probability function and is calculated by:
scaling the data representing concentrations of the hydrogen, the carbon monoxide, methane, carbon dioxide and nitrogen so that the concentrations add up to 100 percent and are thereby scaled concentrations;
determining a current recovery percentage of the hydrogen by determining a difference of the scaled concentrations between the hydrogen in the feed stream and in the tail gas stream and dividing the difference with a quantity equal to a scaled concentration of the hydrogen in the tail gas stream subtracted from one and multiplying the quantity by a further scaled concentration of the hydrogen in the feed stream; and
determining the imputed flow rate of the feed stream by dividing the product flow rate of the hydrogen product stream by a product of the current recovery percentage and the current further scaled concentration of the hydrogen in the feed stream.

6. The method of claim 5, wherein the performance of the adsorption unit is effected when a temperature of the feed stream is below a specific temperature, the feed stream data also includes temperature data related to the temperature of the feed stream and the optimal capacity factor is also adjusted within the feed forward level of control, when the temperature is below the specific temperature, by subtracting from the optimal capacity factor a value equal to a product of a constant and a difference between the temperature of the feed stream and the specific temperature.

7. The method of claim 6, wherein:
current bed loadings are calculated for methane, carbon dioxide and carbon monoxide present within the feed stream with the use of the feed stream data, the imputed flow rate of the feed stream and a cycle time either inputted into the control system as additional data or derived from the data related to the measured flow rate and the current capacity factor;
current loading ratios are calculated for each of the impurities within the feed stream with the use of predetermined design bed loadings; and
the design bed loadings are utilized within the probability function.

8. The method of claim 7, wherein the optimal capacity factor is determined by solving the probability function for an optimal cycle time and then calculating the optimal capacity factor with the use of the optimal cycle time and the measured flow rate of the feed stream.

9. The method of claim 8, wherein the feed stream data also includes raw data of raw concentrations of the hydrogen, the carbon monoxide, the methane, the carbon dioxide and the nitrogen present in the feed stream, a sum of the raw concentrations is compared with a predetermined tolerance and if the sum exceeds the tolerance, the data referable to the current flow rate and the current concentration of the feed stream is determined from the flow rates of product streams emanating from unit operations that are combined to form the feed stream along with assumed compositions of such product streams.
